(19) United States
(12) Patent Application Publication
(10) Pub. No.: US 2026/0298173 A1
(43) Pub. Date: Oct. 1, 2026

(54) CYLINDER BLOCK OF INTERNAL COMBUSTION ENGINE

(71) Applicant: HONDA MOTOR CO., LTD., Tokyo (JP)

(72) Inventors: Noriyuki SUZUKI, Tokyo (JP); Hayato YAMASHIRO, Tokyo (JP); Kazuya TAJIRI, Tokyo (JP); Kazunari KATO, Tokyo (JP); Nobuhiro TERAOKA, Tokyo (JP); Hisayoshi OGURA, Tokyo (JP)

(21) Appl. No.: 19/444,359

(22) Filed: Jan. 9, 2026

(30) Foreign Application Priority Data
Mar. 31, 2025 (JP) 2025-059060

(51) Int. Cl. F02F 1/10

(52) U.S. Cl. CPC F02F 1/10

(57) ABSTRACT

A cylinder block of an internal combustion engine includes: a cylinder sleeve cast into an outer periphery of a cylinder; a cylinder barrel cast around an outer periphery of the cylinder sleeve; a water jacket formed outside the cylinder barrel; and bolt holes for at least four stud bolts disposed to surround the cylinder, in which, in the cylinder barrel, when seen in an axial direction of the cylinder, a wall thickness outside a chord parallel to a crankshaft at a predetermined distance from a center of the cylinder is set greater than a wall thickness outside a chord perpendicular to a crankshaft at a predetermined distance from the center of the cylinder.

### BACKGROUND

### 1. Technical Field

The present invention relates to a cylinder block of an internal combustion engine.

### 2. Description of the Background

Conventionally, to manufacture a cylinder block of an internal combustion engine, a cylinder block having a complex shape is cast, and cylindrical cylinder sleeves are press-fit to cylinder bore sections of the cylinder block.

Cylinder barrels to surround the cylinder sleeves are disposed around the outer peripheries of the cylinder sleeves of the cylinder block. In consideration of the pressure that is applied when the cylinder sleeves are press-fit, the cylinder barrels are given wall thicknesses which are so-called “reinforced wall thicknesses.”

JP-H9-079085-A discloses a technology in which the outer periphery of a cylinder barrel is formed in an oval shape having its major axis along an axis lying in a direction perpendicular to the crankshaft when seen in the axial direction of the cylinder and having its minor axis lying in a direction parallel to the crankshaft. The purpose of this is to give an additional wall thickness to the peripheral wall in a direction (intake-exhaust direction) perpendicular to the crankshaft of the cylinder barrel and to give sufficient strength.

### CITATION LIST

### Patent Literature

Patent Literature 1: JP-H9-079085-A

### BRIEF SUMMARY

In a case where a cylinder sleeve is press-fit into a cylinder bore after a cylinder block is cast, the wall thickness of the cylinder barrel needs to be designed in consideration of the pressure that is applied when the cylinder sleeve is press-fit.

It is possible, as in Patent Document 1, to form the outer periphery of a cylinder barrel in an oval shape having its major axis along an axis lying in a direction perpendicular to the crankshaft when seen in the axial direction of the cylinder and having its minor axis lying in a direction parallel to the crankshaft; however, precise design is difficult since an appropriate wall thickness is given to the oval shape, and there is a possibility that the man-hours for design increase or that the thickness of the cylinder barrel increases, leading to weight increase.

In view of this, an object of the present invention is to provide a cylinder block of an internal combustion engine that allows simplified design and allows for weight reduction while reducing the effects of thermal distortion.

In order to achieve the object described above, a cylinder block of an internal combustion engine according to the present invention includes: a cylinder sleeve cast into an outer periphery of a cylinder; a cylinder barrel cast around an outer periphery of the cylinder sleeve; a water jacket formed outside the cylinder barrel; and bolt holes for at least four stud bolts disposed to surround the cylinder outside the water jacket, in which, in the cylinder barrel, when seen in an axial direction of the cylinder, a wall thickness outside a chord extending in a crankshaft direction at a predetermined distance from a center of the cylinder is set greater than a wall thickness outside a chord perpendicular to a crankshaft at a predetermined distance from the center of the cylinder.

According to this configuration, the wall thickness of the cylinder barrel outside the chord extending in the crankshaft direction at the predetermined distance from the cylinder center when seen in the axial direction the cylinder is set greater than the wall thickness of the cylinder barrel outside the chord perpendicular to the crankshaft when seen in the axial direction of the cylinder. This allows simplified design. In addition, due to the structure, the design can focus on the wall thickness of the cylinder barrel in the intake-exhaust direction which is relatively weak in strength, that is, in the direction perpendicular to the crankshaft, and can ensure sufficient strength against press-fitting of the cylinder sleeve and against the cylinder internal pressure applied at the time of air-fuel mixture combustion. This allows simplified design.

In addition, compared with the conventional technology described above in which the outer periphery of the cylinder barrel is formed in an oval shape when seen in the axial direction of the cylinder, it is not necessary to perform design to meet requirements regarding both a complex outer peripheral surface and wall thickness strength. This allows simplified design, and it is possible to set a greater thicker area of the cylinder barrel having structural strength.

In the configuration, when seen in the axial direction of the cylinder, the cylinder barrel may have points of flexure near the bolt holes for the stud bolts, the points of flexure being points where the wall thickness outside the chord perpendicular to the crankshaft varies to the wall thickness outside the chord extending in the crankshaft direction.

According to this configuration, it is possible to determine ranges where the wall thickness of the cylinder barrel is great on the basis of the positions of the bolt holes for the stud bolts, and design and processing can be made easier.

In the configuration, when seen in the axial direction of the cylinder, an outer peripheral surface of the cylinder barrel may lie along an arcuate section outside the chord perpendicular to the crankshaft at the predetermined distance from the center of the cylinder, pass through an arc with a predetermined radius from a center of a bolt hole for a stud bolt, and be connected to an arcuate section outside the chord extending in the crankshaft direction at the predetermined distance from the center of the cylinder.

According to this configuration, variations in the wall thickness of the cylinder barrel between the wall thicknesses can be made smooth. In addition, the axial force from the stud bolts that is applied when the stud bolts are fastened can be caused to be applied evenly to the peripheries of the bolt holes for the stud bolts, and imbalances in the deformation of the cylinder bores can be reduced.

In the configuration, the water jacket may be formed with a substantially uniform width at an outer periphery of the cylinder barrel in a thickness direction of the cylinder barrel.

According to this configuration, although the wall thickness of the cylinder barrel varies in the circumferential direction, the water jacket is formed with a substantially uniform width around the outer periphery of the cylinder barrel in the thickness direction of the cylinder barrel. Accordingly, cooling water can be distributed smoothly.

In the configuration, when seen in the axial direction of the cylinder, an outer periphery of the cylinder barrel outside the chord extending in the crankshaft direction at the predetermined distance from the center of the cylinder may be formed in an arc or in an arcuate shape centered on a point offset from the center of the cylinder by a predetermined distance in a direction perpendicular to the crankshaft.

According to this configuration, the outer peripheral shape of the cylinder barrel outside the chord extending in the crankshaft direction at the predetermined distance from the center of the cylinder is an arc or an arcuate shape, and design is easy.

In addition, the shape of the outer periphery of the cylinder barrel forms a gentler arc than an oval shape, and variations in the cross-sectional area become smaller. Accordingly, deformation due to temperature variations is reduced further.

In the configuration, when seen in the axial direction of the cylinder, a wall thickness of the cylinder barrel outside the chord extending in the crankshaft direction at the predetermined distance from the center of the cylinder may be a uniform thickness.

According to this configuration, when seen in the axial direction of the cylinder, the outer periphery of the cylinder barrel outside the chord extending in the crankshaft direction at the predetermined distance from the center of the cylinder becomes circular, and its center coincides with the center of the cylinder. Accordingly, dimensional management becomes easier.

In the present invention, a cylinder block of an internal combustion engine includes: a cylinder sleeve cast into an outer periphery of a cylinder; a cylinder barrel cast around an outer periphery of the cylinder sleeve; a water jacket formed outside the cylinder barrel; and bolt holes for at least four stud bolts disposed to surround the cylinder outside the water jacket, in which, in the cylinder barrel, when seen in an axial direction of the cylinder, a wall thickness outside a chord extending in a crankshaft direction at a predetermined distance from a center of the cylinder is set greater than a wall thickness outside a chord perpendicular to a crankshaft at a predetermined distance from the center of the cylinder.

The configuration described above makes it possible to design a cylinder barrel with a simple design policy that a chord extending in the crankshaft direction at a predetermined distance from the center of a cylinder when seen in the axial direction of the cylinder and a chord perpendicular to the crankshaft at a predetermined distance from the center of the cylinder are determined, and a wall thickness of the cylinder barrel outside the chord extending in the crankshaft direction is set greater than a wall thickness of the cylinder barrel outside the chord perpendicular to the crankshaft. When the wall thicknesses of the cylinder barrel are determined, the wall thicknesses of thicker portions of the cylinder barrel can be determined in consideration of press-fitting of the cylinder sleeve and the internal pressure of the cylinder. Thereby, a cylinder block of an internal combustion engine that is easy to set can be provided.

In addition, due to the configuration described above, the effects of thermal distortion can be reduced compared to a cylinder barrel whose wall thickness varies in a complex manner such as a cylinder barrel whose outer periphery when seen in the axial direction of cylinders is an oval shape. In addition, a light-weight cylinder block of an internal combustion engine can be produced, avoiding excessive wall thicknesses compared to a cylinder barrel having such complex wall thickness variations.

### BRIEF DESCRIPTION OF DRAWINGS

FIG. 1 is an overall side view of a motorcycle equipped with a cylinder block of an internal combustion engine according to an embodiment of the present invention.

FIG. 2 is a left side view illustrating the positional relationship of arrangement of the cylinder block and a crankshaft of an internal combustion engine.

FIG. 3 is a plan view of the cylinder block of an internal combustion engine according to the embodiment of the present invention with a cylinder head thereof being removed.

FIG. 4 is a drawing of the cylinder block of an internal combustion engine according to the embodiment of the present invention as seen in the axial direction of cylinders.

FIG. 5 is a cross-sectional view illustrating the cylinder block of an internal combustion engine according to the embodiment of the present invention taken along the axis of a cylinder.

FIG. 6 is an enlarged view of one cylinder of the cylinder block of an internal combustion engine according to the embodiment of the present invention as seen in the axial direction.

FIG. 7 is an explanatory diagram illustrating an enlarged view of a wall thickness varying section of a cylinder barrel of the cylinder block of an internal combustion engine according to the embodiment of the present invention.

FIG. 8 is a drawing of a cylinder block of an internal combustion engine according to a second embodiment of the present invention as seen in the axial direction of a cylinder.

### DETAILED DESCRIPTION

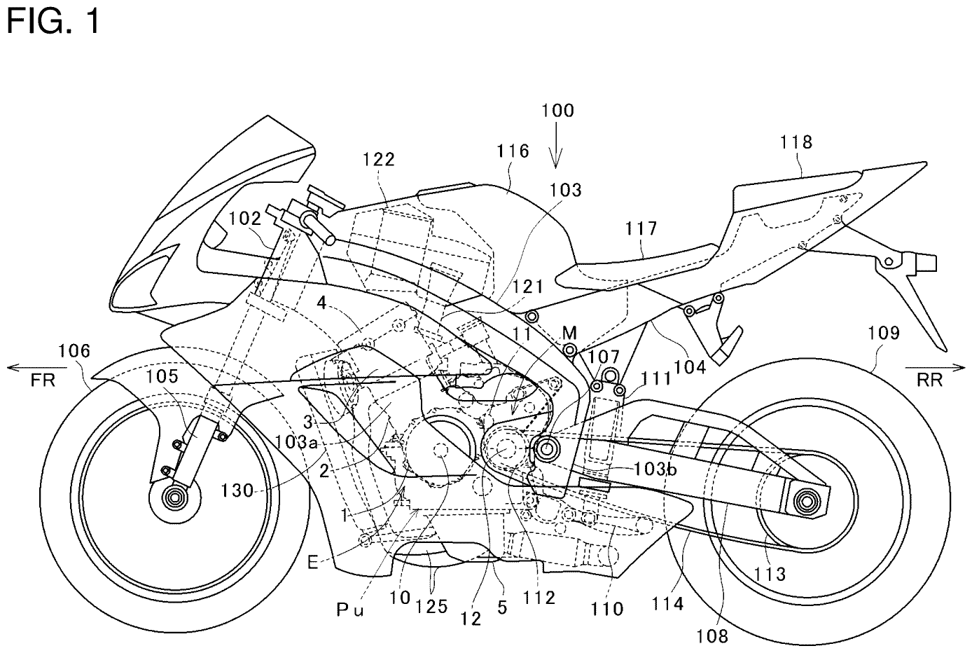

Hereinbelow, an embodiment according to the present invention is explained on the basis of FIG. 1 to FIG. 7.

FIG. 1 is a side view of a motorcycle 100, which is a saddled vehicle equipped with a cylinder block of an internal combustion engine according to the embodiment to which the present invention is applied.

Note that the technical idea according to the present invention can be applied not only to a cylinder block of an internal combustion engine of a motorcycle, but also to a four-wheel vehicle, but is suited for a cylinder block of an internal combustion engine of a motorcycle.

In the present specification and claims, the forward, rearward, left, and right directions follow the typical reference in which the forward direction of the motorcycle 100 according to the present embodiment is defined as the forward direction. In the drawings, FR represents the forward direction, RR represents the rearward direction, LH represents the left direction, and RH represents the right direction.

The body frame of the motorcycle 100 includes a pair of left and right main frames 103 that branches leftward and rightward and extends diagonally downward in the rearward direction from a head pipe 102 that steerably supports a front fork 105 that pivotably supports a front wheel 106.

An engine hanger section 103a hangs from a lower portion of the front section of the main frames 103. The rear section of the main frames 103 is bent, and a pivot frame section 103b extends downward from the rear section of the main frames 103.

A seat rail 104 is coupled to and extends rearward from a rearward portion of the center of the main frames 103.

A swing arm 108 whose front end is pivotably supported by the pivot frame section 103b at a pivot shaft 107 extends rearward, and a rear wheel 109 is pivotably supported by the rear end of the swing arm 108.

A link mechanism 110 is provided between the swing arm 108 and the pivot frame section 103b, and a rear cushion 111 is interposed between a part of the link mechanism 110 and the seat rail 104.

The body frame includes: a power unit Pu suspended between the engine hanger section 103a and the pivot frame section 103b of the main frames 103; and a traveling driving chain 114 mounted across a traveling driving sprocket 112 fitted to an output shaft which is a countershaft 12 of a transmission M of the power unit Pu and a traveling driven sprocket 113 fitted to the rear axle of the rear wheel 109.

An air cleaner 122 is mounted across the front half of the main frames 103, and a fuel tank 116 is mounted across the rear half of the main frames 103. Behind the fuel tank 116, a main seat 117 and a pillion seat 118 are provided being supported by the seat rail 104.

An internal combustion engine E occupying the front half of the power unit Pu is an inline two-cylinder, water-cooled, four-stroke internal combustion engine with a transversely mounted crankshaft, and is mounted on the body frame with the cylinders being in moderately forward-inclining postures.

A crankshaft 10 of the internal combustion engine E is pivotably supported by a crankcase 1 in a state where the crankshaft 10 is oriented in the vehicle-width direction (left/right direction), and the crankcase 1 integrally includes the transmission M behind the crankshaft 10.

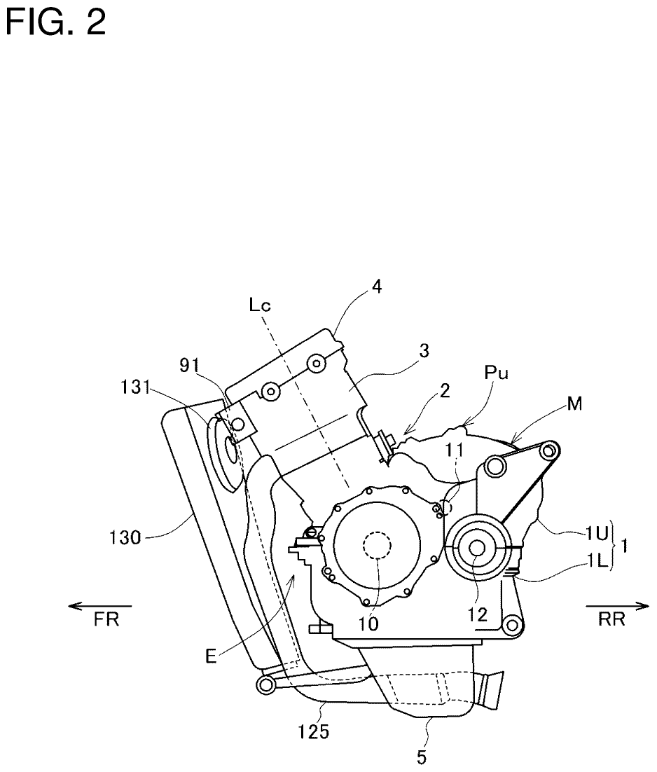

Referring to FIG. 2, above the crankcase 1, the internal combustion engine E includes an engine body including: a cylinder block 2 in which the two cylinders are arrayed in an inline configuration; a cylinder head 3 coupled to the upper section of the cylinder block 2 via a gasket; and a cylinder head cover 4 covering the upper section of the cylinder head 3.

A cylinder axis Lc, which is the central axis line of cylinder bores of the cylinder block 2, is inclined forward. The cylinder block 2, the cylinder head 3, and the cylinder head cover 4 that are placed one on another above the crankcase 1 extend upward in slightly forward-inclining postures from the crankcase 1.

In addition, an oil pan 5 is provided protruding downward below the crankcase 1.

Referring to FIG. 1 and FIG. 2, a radiator 130 is disposed in a forward-inclining posture along the front surface of the slightly forward-inclining engine body.

Note that radiator fans 131 are provided on the left and right sides of the rear surface of the radiator 130.

The crankcase 1 has an upper-lower split configuration, and the crankshaft 10 is pivotably supported by being sandwiched by the split surfaces of an upper crankcase 1U and a lower crankcase 1L.

The crankcase 1 houses the transmission M behind the crankshaft 10. A main shaft 11 and the countershaft 12 included in the transmission M are pivotably supported by the crankcase 1 with the main shaft 11 and the countershaft 12 being oriented in the vehicle-width direction parallel to the crankshaft 10 (see FIG. 2).

The main shaft 11 and the countershaft 12 of the transmission M are disposed in the transmission chamber of the crankcase 1 in a state where the main shaft 11 and the countershaft 12 are oriented in the horizontal left-right directions parallel to the crankshaft 10. The countershaft 12 penetrates the crankcase 1 leftward, protrudes to the outside, and serves as the output shaft.

On the rear side surface of the cylinder head 3, an intake pipe extending from each cylinder is connected to the air cleaner 122 via a throttle body 121 (see FIG. 1).

In addition, on the front side surface of the cylinder head 3, an exhaust pipe 125 extends from each cylinder. Each exhaust pipe 125 extends downward, bends rearward, and extends rearward on the right side of the oil pan 5.

At the cylinder head 3, the internal combustion engine E includes a 4-valve-system valve gear with a DOHC structure.

In the present example, the internal combustion engine E is assembled by placing, one on another above the oil pan 5, the crankcase 1 (lower crankcase 1L, upper crankcase 1U), the cylinder block 2, the cylinder head 3, and the cylinder head cover 4 in this order.

Note that the cylinder block 2 and the crankcase 1 (upper crankcase 1U) may be an integrated body or the cylinder block 2 and the crankcase 1 (upper crankcase 1U) may be separate bodies.

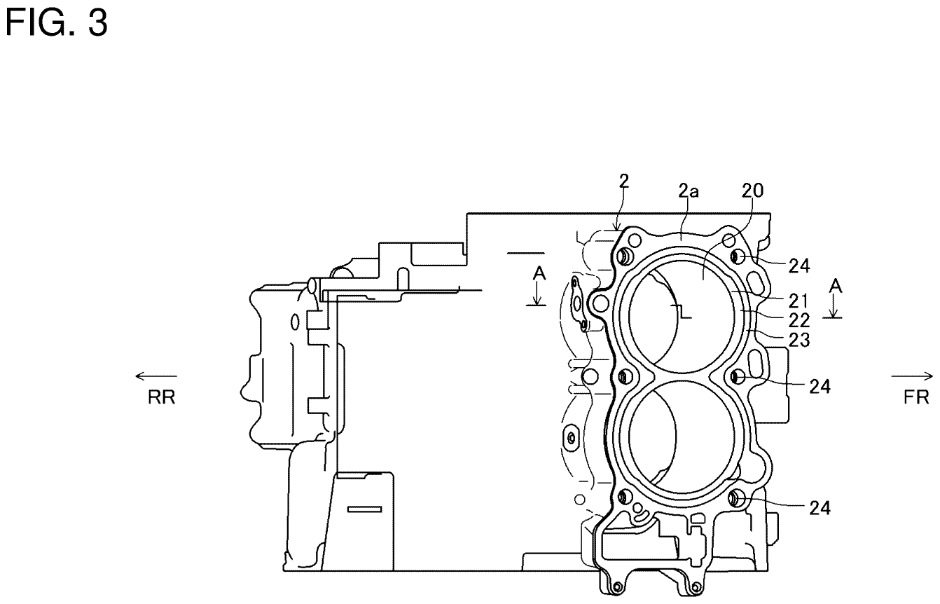

FIG. 3 is a plan view of the cylinder block 2 of the internal combustion engine E according to the present embodiment with the cylinder head 3 being removed.

Note that, whereas the cylinder block 2 is cast integrally with the crankcase 1 (upper crankcase 1U) in the example illustrated in the drawings, as described before, the cylinder block 2 and the crankcase 1 may be formed and assembled as separate bodies.

As illustrated in FIG. 3, an upper surface 2a of the cylinder block 2 is a bonding surface with the unillustrated cylinder head 3. Cavities where cylinders 20 are formed are formed in the cylinder block 2, as can be seen from the bonding surface of the cylinder block 2 with the cylinder head 3.

Cylinder sleeves 21 are disposed around the outer peripheries of the cylinders 20, and cylinder barrels 22 are disposed around the outer peripheries. In the present embodiment, the cylinder sleeves 21 and the cylinder barrels 22 are cast integrally.

A cavity section for a water jacket 23 where a coolant is distributed is formed outside the cylinder barrels 22. Further outside the water jacket 23, bolt holes 24 for at least four stud bolts 7 (not illustrated) are formed for each cylinder so as to surround the cylinders 20.

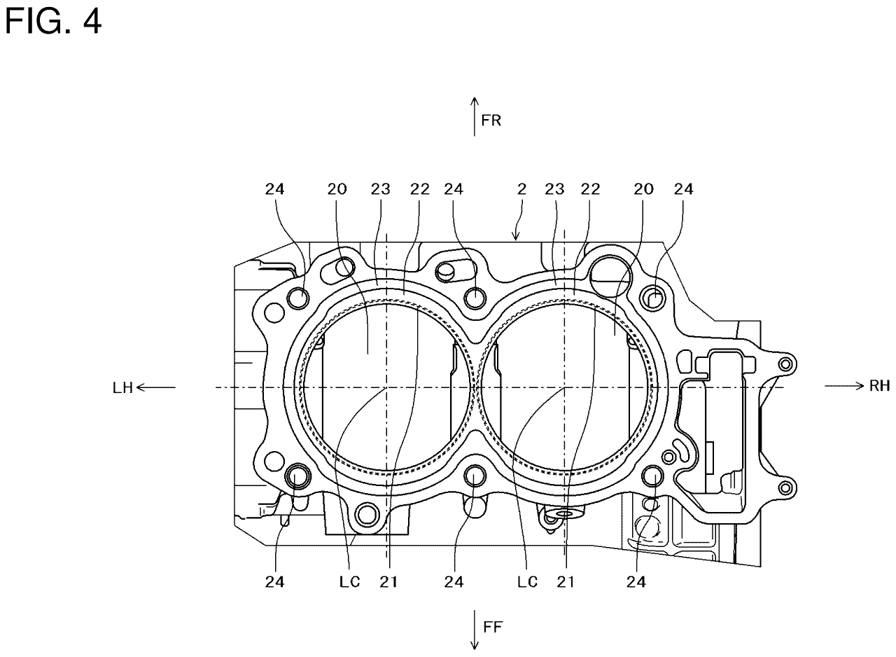

FIG. 4 is a drawing of the cylinder block 2 of the internal combustion engine E according to the present embodiment as seen in the axial direction of the cylinders 20.

Each cylinder 20 has a circular cylinder bore, and has the cylinder axis Lc at its center. The cylinder sleeve 21 is cast into the inner periphery of the cylinder bore. The cylinder barrel 22 is cast around the outer periphery of the cylinder sleeve 21. The cylinder sleeve 21 includes a wear-resistant metal such as cast iron. Around the outer periphery of the cylinder sleeve 21, the other portions than the cylinder sleeve 21 of the aluminum-alloy cylinder block 2 are cast integrally with the cylinder sleeve 21. Many protrusions (spiny protrusions) are preferably formed on the surface of the cylinder sleeve 21. In this case, the boundary between the cylinder sleeve 21 and the cylinder barrel 22 has an intricate shape. Accordingly, this is represented by a double dotted line in FIG. 4.

Note that the cylinder sleeve 21 may be press-fit to the cylinder bore section after a certain length of time has passed since the cylinder block 2 is cast. In this case, the cylinder sleeve 21 to be used is a cylinder sleeve whose outer peripheral surface has a smooth cylindrical shape.

The water jacket 23, which is a cavity where a coolant is distributed, is formed outside the cylinder barrels 22. The aluminum-alloy wall body of the cylinder block 2 is formed outside the water jacket 23. The bolt holes 24 for the at least four stud bolts 7 for each cylinder are formed through the aluminum-alloy wall body so as to surround the cylinders 20. At the time of assembly, the stud bolts 7 are inserted through the bolt holes 24, and the cylinder block 2 and the cylinder head 3 are fastened together.

Note that the cylinder sleeves 21 may be formed in discrete cylindrical shapes or the adjacent cylinder sleeves 21 may be formed integrally.

The present invention can be applied also to a single cylinder engine, but is suitably applied to an engine having parallel cylinders.

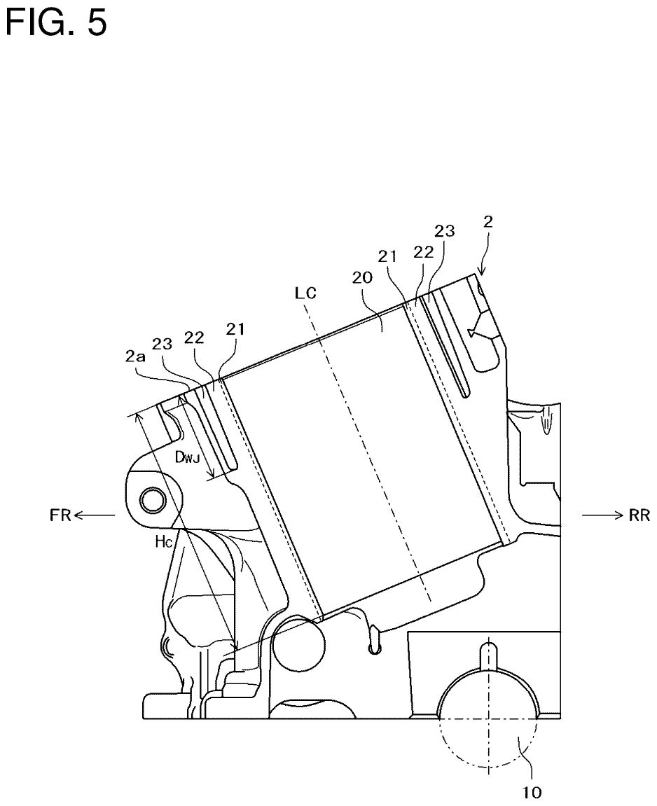

FIG. 5 is a cross-sectional view of the cylinder block 2 taken along the axis Lc of a cylinder as seen in the A-A arrow direction illustrated in FIG. 2.

As illustrated in FIG. 5, the axis Lc of the cylinder 20 is slightly inclined forward. The cylinder sleeve 21, the cylinder barrel 22, and the water jacket 23 are formed in this order on the outer periphery of the cylinder 20.

The water jacket 23 has a depth D_{WJ}, slightly expands upward, and has an opened upper end. The depth D_{WJ} of the water jacket 23 is formed to be generally one half to one third (½ to ⅓) of the cylinder length Hc.

As illustrated in FIG. 2, FIG. 3, and FIG. 4, the crankshaft 10 is disposed in the left-right direction parallel to the array direction of the cylinders 20. The intake-exhaust direction (IN-EXH direction) of the cylinders is disposed in a direction perpendicular to the crankshaft 10.

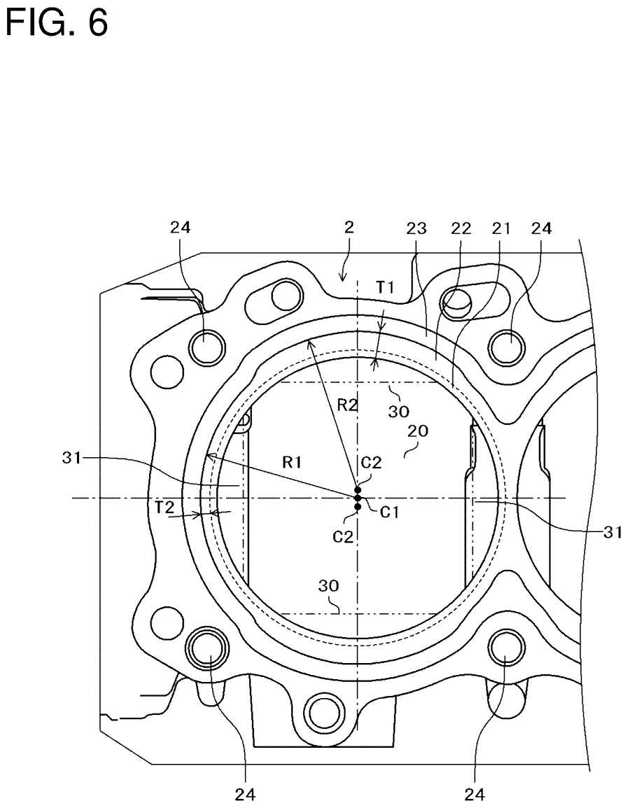

FIG. 6 is an enlarged view of one cylinder 20 as seen in the axial direction.

As illustrated in FIG. 6, when seen in the axial direction of the cylinder 20, in the cylinder barrel 22, a wall thickness T1 outside each chord 30 extending in the crankshaft direction at a predetermined distance from the cylinder center C1 is set greater than a wall thickness T2 outside each chord 31 perpendicular to the crankshaft at a predetermined distance from the center C1 of the cylinder. That is, the cylinder barrel 22 is designed such that T1>T2.

The wall thicknesses T1 and T2 of the cylinder barrel 22 may be determined according to the requirements of each internal combustion engine such as the internal pressure of the cylinders or the press-fit strength of the cylinder sleeves.

The wall thickness T1 of the cylinder barrel outside the chord 30 extending in the crankshaft direction can be made a uniform thickness; however, for weight reduction, the wall thickness of the cylinder barrel outside the chord 30 extending in the crankshaft direction at the predetermined distance from the cylinder center C1 can be made a varying thickness.

As a preferable example, as illustrated in FIG. 6, when seen in the axial direction of the cylinder 20, the outer periphery of the cylinder barrel 22 outside the chord 30 extending in the crankshaft direction at the predetermined distance from the cylinder center C1 can be formed in an arc or in an arcuate shape centered on a point C2 offset from the cylinder center C1 by a predetermined distance in a direction perpendicular to the crankshaft (i.e. in the front-rear direction or the intake-exhaust direction). Note that the arcuate shape means a shape including an arcuate curve similar to an arc.

In a case where the outer periphery of the cylinder barrel 22 outside the chord 30 is an arc centered on the point C2, a radius R2 from the point C2 to the outer periphery of the cylinder barrel 22 may satisfy the relationship R2>=R1, which is a radius from the cylinder center C1 to the outer periphery of the cylinder barrel 22 outside the chord 31.

In addition, the radius R2 from the point C2 to the outer periphery of the cylinder barrel 22 may vary, and the outer periphery of the cylinder barrel 22 outside the chord 30 may have an arcuate shape.

Forming the outer periphery of the cylinder barrel outside the chord 30 extending in the crankshaft direction at the predetermined distance from the cylinder center C1 in an arc or in an arcuate shape centered on the point C2 offset from the cylinder center C1 by the predetermined distance in the direction perpendicular to the crankshaft (i.e. the front-rear direction or the intake-exhaust direction) in this manner allows for partial reduction of the wall thickness T1 of the cylinder barrel 22 outside the chord 30 compared to a case where the wall thickness T1 is a uniform thickness and allows for weight reduction.

In addition, in the cylinder block 2 illustrated in FIG. 6, the shape of the outer periphery of the cylinder barrel forms a gentler arc than an oval shape, and variations in the cross-sectional area become smaller. Accordingly, deformation due to temperature variations is smaller.

As illustrated in FIG. 6, the water jacket 23 may be formed with a substantially uniform width at the outer periphery of the cylinder barrel 22 in the thickness direction of the cylinder barrel 22.

Here, the thickness direction of the cylinder barrel 22 is a radial direction related to the cylinder center C1 in the case of the wall thickness T2 of the cylinder barrel 22 outside the chord 31, and is a radial direction related to the point C2 offset from the cylinder center C1 by the predetermined distance in the direction perpendicular to the crankshaft in the case of the wall thickness T1 of the cylinder barrel 22 outside the chord 30.

By setting the width of the water jacket 23 to a substantially uniform width in the thickness direction of the cylinder barrel 22, it becomes possible to cause a coolant to flow smoothly and to uniformly cool the cylinder barrel 22 independently of the thickness of the cylinder barrel 22.

As described above, in the present invention, when seen in the axial direction of the cylinder 20, the wall thickness T1 of the cylinder barrel 22 outside the chord 30 extending in the crankshaft direction at the predetermined distance from the cylinder center C1 is set greater than the wall thickness T2 of the cylinder barrel 22 outside the chord 31 perpendicular to the crankshaft at the predetermined distance from the cylinder center C1 (T1>T2).

Accordingly, in the cylinder barrel 22, there are points of flexure where the wall thickness T2 varies to the wall thickness T1.

Preferably, when seen in the axial direction of the cylinder 20, the cylinder barrel 22 has points of flexure near the bolt holes 24 for the stud bolts, the points of flexure being points where the wall thickness T2 outside the chord 31 perpendicular to the crankshaft varies to the wall thickness T1 outside the chord 30 extending in the crankshaft direction.

By providing the points of flexure where the wall thickness of the cylinder barrel 22 varies near the bolt holes 24 for the stud bolts in this manner, ranges where the cylinder barrel 22 becomes thick can be determined on the basis of the stud positions, and design/processing becomes easier.

The wall thickness T2 of the cylinder barrel 22 outside the chord 31 perpendicular to the crankshaft preferably varies smoothly to the wall thickness T1 of the cylinder barrel 22 outside the chord 30 extending in the crankshaft direction.

That is, when seen in the axial direction of the cylinder 20, the outer peripheral surface of the cylinder barrel 22 preferably has a smoothly curved connection between the outer portion of the chord 31 perpendicular to the crankshaft at the predetermined distance from the cylinder center C1 and the outer portion of the chord 30 extending in the crankshaft direction at the predetermined distance from the cylinder center C1.

Typically, making the outer periphery of the cylinder barrel 22 a smooth curve is preferable since localized stress concentration can be avoided thereby.

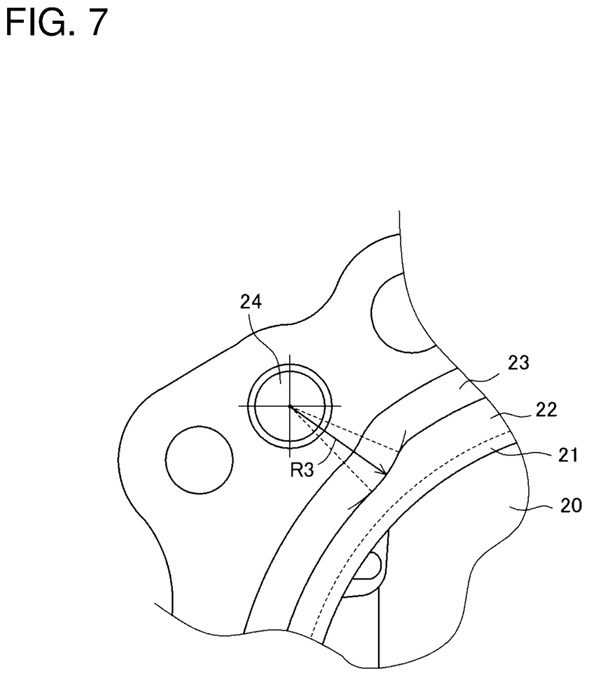

To illustrate an example in which the outer periphery of the cylinder barrel 22 is made a smooth curve, FIG. 7 is an enlarged view of the wall thickness varying section of the cylinder barrel 22 of the cylinder block 2.

In the example illustrated in FIG. 7, when seen in the axial direction of the cylinder 20, the outer peripheral surface of the cylinder barrel 22 lies along the arcuate section outside the chord 31 perpendicular to the crankshaft at the predetermined distance from the cylinder center C1, passes through an arc with a predetermined radius R3 from the center of a bolt hole 24 for a stud bolt, and is smoothly connected to the arcuate section outside the chord 30 extending in the crankshaft direction at the predetermined distance from the cylinder center C1. Here, the arcuate section means a section including an arc or an arcuate curved portion.

Due to the configuration described above, variations in the wall thickness of the cylinder barrel 22 between the wall thicknesses T1 and T2 can be made smooth.

In addition, according to the configuration described above, in a case where the stud bolts 7 (not illustrated) are fastened, the axial force from the stud bolts 7 is applied evenly to the cylinder barrel 22 or the water jacket 23 at equal distances from the stud bolts 7. Accordingly, imbalances in the deformation of the cylinder bores can be reduced.

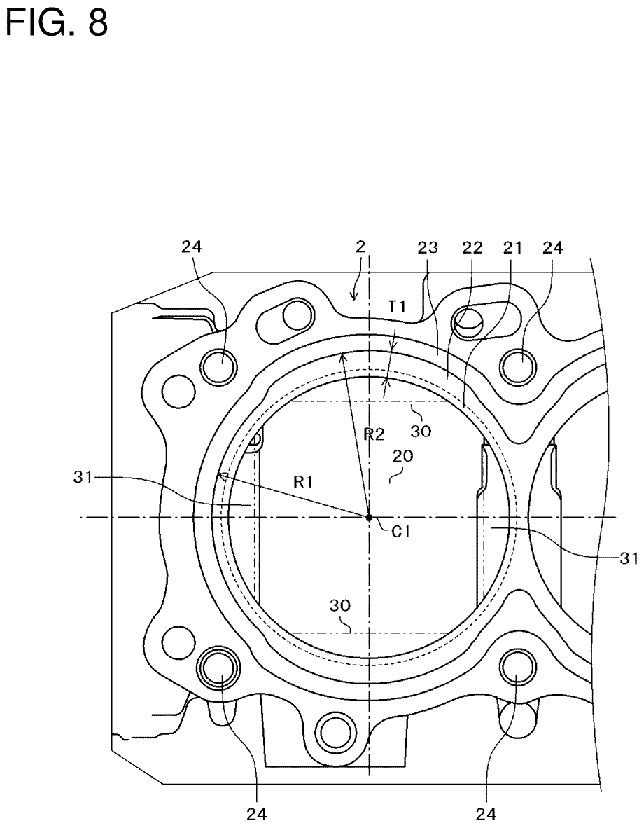

FIG. 8 illustrates a second embodiment of a cylinder block of an internal combustion engine according to the present invention.

FIG. 8 illustrates one cylinder of a cylinder block 2′ according to the second embodiment as seen in the cylinder axis direction.

Note that constituent elements in FIG. 8 which are identical to those in FIG. 1 to FIG. 7 are given identical reference signs, and the same explanation is not repeated.

In the cylinder block 2′ according to the present embodiment, when seen in the axial direction the cylinder, a wall thickness of a cylinder barrel 23 outside the chord 30 extending in the crankshaft direction at the predetermined distance from the cylinder center C1 is set to a uniform thickness.

As a specific design method, as illustrated in FIG. 8, the two radii R1 and R2 (R2>R1) are determined. When seen in the axial direction of the cylinder 20, the outer periphery of the cylinder barrel 22 outside the chord 30 extending in the crankshaft direction at the predetermined distance from the cylinder center C1 can be designed as an arc centered on the cylinder center C1 and having the radius R2, and the outer periphery of the cylinder barrel 22 outside the chord 31 perpendicular to the crankshaft at the predetermined distance from the cylinder center C1 can be designed as an arc having the radius R1 from the cylinder center C1.

Due to the shared center (cylinder center C1) and the relationship R2>R1, the wall thickness of the cylinder barrel 23 outside the chord 30 extending in the crankshaft direction at the predetermined distance from the cylinder center C1 is set to a uniform thickness.

By setting the wall thickness T1 of the cylinder barrel to a uniform thickness, the shape of the outer periphery of the cylinder barrel 22 becomes a circular shape, and its center coincides with the cylinder center C1. Accordingly, dimensional management becomes easier. In addition, strength calculations for design also become easier.

Embodiments of the cylinder block 2 of an internal combustion engine according to the present invention have been explained thus far. Aspects of the present invention are not limited to the embodiments described above, and the present invention incorporates those implemented in various aspects within the scope of the gist of the present invention.

### REFERENCE SIGNS LIST

Pu: Power unit
E: Internal combustion engine
M: Transmission
Cylinder axis Lc
Depth D_{WJ} of water jacket
Cylinder length Hc
Cylinder center C1
Point C2 offset from cylinder center in direction perpendicular to crankshaft by predetermined distance
Wall thickness T1 of cylinder barrel outside chord extending in crankshaft direction
Wall thickness T2 of cylinder barrel outside chord perpendicular to crankshaft
1: Crankcase
1U: Upper crankcase
1L: Lower crankcase
2: Cylinder block
3: Cylinder head
4: Cylinder head cover
5: Oil pan
7: Stud bolt
10: Crankshaft
11: Main shaft
12: Countershaft
20: Cylinder
21: Cylinder sleeve
22: Cylinder barrel
23: Water jacket
24: Bolt hole
Chord 30 extending in crankshaft direction
Chord 31 perpendicular to crankshaft
100: Motorcycle
102: Head pipe
103: Main frame
103a: Engine hanger section
103b: Pivot frame section
104: Seat rail
105: Front fork
106: Front wheel
107: Pivot shaft
108: Swing arm
109: Rear wheel
110: Link mechanism
111: Rear cushion
112: Traveling driving sprocket
113: Traveling driven sprocket
114: Traveling driving chain
116: Fuel tank
117: Main seat
118: Pillion seat
121: Throttle body
122: Air cleaner
125: Exhaust pipe
130: Radiator
131: Radiator fan

What is claimed is:

1. A cylinder block of an internal combustion engine, the cylinder block comprising:
a cylinder sleeve cast into an outer periphery of a cylinder;
a cylinder barrel cast around an outer periphery of the cylinder sleeve;
a water jacket formed outside the cylinder barrel; and
bolt holes for at least four stud bolts disposed to surround the cylinder, wherein in the cylinder barrel, when seen in an axial direction of the cylinder, a wall thickness outside a chord extending in a crankshaft direction at a predetermined distance from a center of the cylinder is set greater than a wall thickness outside a chord perpendicular to a crankshaft at a predetermined distance from the center of the cylinder.

2. The cylinder block of an internal combustion engine according to claim 1, wherein, when seen in the axial direction of the cylinder, the cylinder barrel has points of flexure near the bolt holes for the stud bolts, the points of flexure being points where the wall thickness outside the chord perpendicular to the crankshaft varies to the wall thickness outside the chord extending in the crankshaft direction.

3. The cylinder block of an internal combustion engine according to claim 1, wherein, when seen in the axial direction of the cylinder, an outer peripheral surface of the cylinder barrel lies along an arcuate section outside the chord perpendicular to the crankshaft at the predetermined distance from the center of the cylinder, passes through an arc with a predetermined radius from a center of a bolt hole for a stud bolt, and is connected to an arcuate section outside the chord extending in the crankshaft direction at the predetermined distance from the center of the cylinder.

4. The cylinder block of an internal combustion engine according to claim 1, wherein the water jacket is formed with a substantially uniform width at an outer periphery of the cylinder barrel in a thickness direction of the cylinder barrel.

5. The cylinder block of an internal combustion engine according to claim 1, wherein, when seen in the axial direction of the cylinder, an outer periphery of the cylinder barrel outside the chord extending in the crankshaft direction at the predetermined distance from the center of the cylinder is formed in an arc or in an arcuate shape centered on a point offset from the center of the cylinder by a predetermined distance in a direction perpendicular to the crankshaft.

6. The cylinder block of an internal combustion engine according to claim 1, wherein, when seen in the axial direction of the cylinder, a wall thickness of the cylinder barrel outside the chord extending in the crankshaft direction at the predetermined distance from the center of the cylinder is a uniform thickness.

7. The cylinder block of an internal combustion engine according to claim 2, wherein, when seen in the axial direction of the cylinder, an outer peripheral surface of the cylinder barrel lies along an arcuate section outside the chord perpendicular to the crankshaft at the predetermined distance from the center of the cylinder, passes through an arc with a predetermined radius from a center of a bolt hole for a stud bolt, and is connected to an arcuate section outside the chord extending in the crankshaft direction at the predetermined distance from the center of the cylinder.

8. The cylinder block of an internal combustion engine according to claim 2, wherein the water jacket is formed with a substantially uniform width at an outer periphery of the cylinder barrel in a thickness direction of the cylinder barrel.
